(19) United States
(12) Patent Application Publication
(10) Pub. No.: US 2008/0276045 A1
(43) Pub. Date: Nov. 6, 2008

(54) Apparatus and Method for Dynamic Cache Management

(75) Inventors: Milind Manohar Kulkarni, Sunnyvale, CA (US); Narendranath Udupa, Karnata KA (IN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/158,994

(22) PCT Filed: Dec. 21, 2006
(86) PCT No.: PCT/IB2006/055011

§ 371 Date: Jun. 23, 2008

(30) Foreign Application Priority Data
Dec. 23, 2006 (IB) PCT/IB2006/055011

(51) Int. Cl. G06F 12/00

(52) U.S. Cl. 711/125; 711/E12.001

(57) ABSTRACT

The apparatus of the present invention improves performance of computing systems by enabling a multi-core or multi-processor system to deterministically identify cache memory (100) blocks that are ripe for victimization and also prevent victimization of memory blocks that will be needed in the immediate future. To achieve these goals, the system has a FIFO with schedule information available in the form of Estimated Production Time (EPT) (102) and Estimated Consumption Time (ECT) (104) counters to make suitable pre-fetch and write-back decisions so that data transmission is overlapped with processor execution.

This invention relates to data processing systems, and particularly to multiprocessor systems having optimized cache management.

Advances in computer hardware and software technologies have resulted in multi-processor computer systems capable of performing highly complex parallel processing by logically partitioning the system resources to different tasks. The processors may reside on one or more processor modules typically having at least two levels of caches.

Caches are typically accessed much faster than main memory. Typically caches are located on the processor module, or within the processors. Caches act as buffers to retain recently used instructions and data to reduce the latencies involved with retrieving the instructions and data from main memory every time the instructions and data are needed.

Some caches retain the most frequently used memory lines from main memory. A memory line is the minimum readable unit of data from the main memory such as eight bytes and a cache line is the corresponding unit in cache. Cache lines store memory lines so the memory lines do not have to be retrieved from the relatively slow main memory each time the memory lines are used.

Typically only the memory lines that are most often used will be stored in the cache because the relatively fast and expensive cache is generally smaller than main memory. Accordingly, cache memory does not normally store all the data required for a processing transactions. This is generally accomplished by tracking the least recently used entries, or cache lines, and replacing the least recently used cache lines with memory lines associated with recent cache requests that cannot be satisfied by the current contents of the cache. Cache requests that can't be satisfied because the cache lines have been shifted to main memory are often called cache misses because the processor sent the request to the cache and missed an opportunity to retrieve the contents of the memory lines from the cache.

Processors typically include a level one (L1) cache to retain copies of oft-used memory lines such as instructions that would otherwise be frequently accessed from a relatively slower main memory. The L1 cache can reduce latencies of potentially thousands of cycles for accessing main memory to a few cycles incurred while accessing the cache. However, L1 cache is generally small because area used within the processor is limited in capacity.

A level two (L2) cache often resides on the processor module, physically close to the processor, offering significantly reduced latencies with respect to access of main memory. L2 cache may be larger than the L1 cache since it is less costly to manufacturer and may be configured to maintain, e.g., a larger number of the recently used memory lines.

The L2 cache may be implemented as a large, shared cache for more than one of the processors in the processor module or as separate, private caches, for each of the processors in the module. A large, shared L2 cache is beneficial for workload demands on processors that involve accesses to a large number of memory lines. For example, when a processor is accessing a large database, a large number of memory lines may be repeatedly accessed. However, if the L2 cache is not sufficiently large to hold that large number of repeatedly accessed memory lines or blocks, the memory lines accessed first may be overwritten (i.e. victimized) and the processor may have to request those blocks from main memory again.

The streaming application models such as YAPI and TSSA consist of tasks communicating through FIFOs. Typically, to reduce the latency of access to the data, the FIFOs are cached. However, sometimes if the average FIFO cache requirements are larger than a single cache can handle resulting in a cache mismatch. This mismatch between the actual cache size and desired cache size leads to victimization of other memory blocks residing in cache in favor of using those memory blocks for a particular FIFO.

For example, in some instances it is possible that a memory block, which will be needed immediately, will be erroneously selected for victimizing resulting in additional, unnecessary data transmission. Another possibility is that a block, which will definitely be not used in the near future and thus is a suitable candidate for victimization, will not be victimized. Therefore, a deterministic method is desired, for indicating which memory block is going to be used for either writing or reading in the immediate near future.

Some systems have been devised that include FIFO registers having an input counting unit and an output counting unit that communicate with a task scheduler. One particular FIFO register type has counters that count expected production time (EPT) for data to be communicated in the FIFO register and expected consumption times (ECT) for data to be communicated in the FIFO register. Such counters can be utilized to minimize inefficient victimization of memory blocks.

The apparatus of the present invention improves performance of computing systems by enabling a multi-core or multi-processor system to deterministically identify cache memory blocks that are ripe for victimization and also prevent victimization of memory blocks that will be needed in the immediate future. To achieve these goals, the system makes use of a FIFO having schedule information available in the form of EPT and ECT counters.

The above summary of the present invention is not intended to represent each disclosed embodiment, or every aspect, of the present invention. Other aspects, details and example embodiments are provided in the drawing and the detailed description that follows.

The invention may be more completely understood in consideration of the following detailed description of various embodiments of the invention in connection with the accompanying drawings, in which:

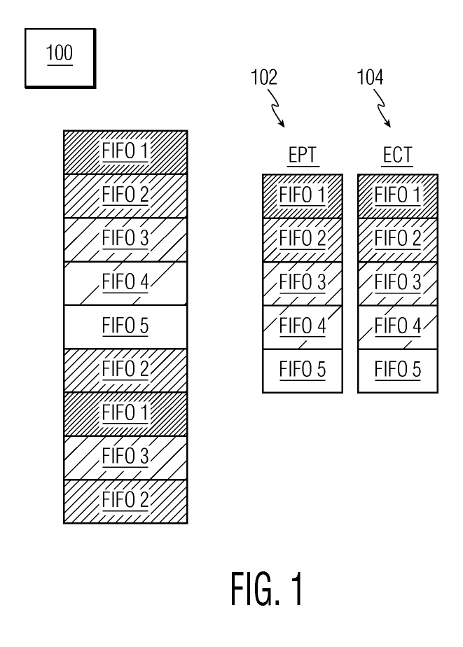

FIG. 1 shows a FIFO buffer and expected production time (EPT) and expected consumption time (ECT) counters.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

FIG. 1 shows a cache 100 including and EPT counter 102 and ECT counter 104. The cache 100 includes five FIFOs occupying a portion of the cache 100. Each FIFO handles data. The cache 100 can be a single level of memory in accordance with one embodiment of the invention. According to another embodiment the cache 100 has multiple levels. A further aspect of the invention includes cache 100, which is shared with multiple processors, or a single processor with multiple processor cores.

The data typically will take the form of work requests from a processor or controller. The work requests are normally organized in a queue or stack. Each queue or stack of work requests are fed to a FIFO and stored (usually temporarily) in a first-in, first-out sequence for further processing. It can be appreciated that although the invention is described in terms of utilizing EPT and ECT counters in a FIFO, the invention can also utilize these counters in conjunction with an LIFO, which handles work requests from a queue or stack in reverse order. Accordingly, The EPT and ECT counters indicate the time (or cycles) left for the possible production or consumption of data in the respective FIFOs.

The EPT counter 102 and ECT 104 counter are associated with any particular FIFO. The EPT counter 102 and ECT counter 104 can be either enabled or disabled.

There are three possibilities that are described as follows: The first possibility is where both EPT 102 and ECT 104 counters of a particular FIFO are disabled, which means that they will not influence any cache related operation of the FIFO they are representing. The second is where either the EPT 102 or ECT 104 counter can be disabled and the other enabled. The third possibility is where both are enabled. There are consequences of each of these three possibilities.

While there are three operational possibilities for these counters at any given time, it can be appreciated that the status (enablement or disablement) of either the EPT or ECT counter can change over time too. In accordance with one aspect of the invention, the status of the EPT or ECT counter be pre-determined. Particularly, either can be enabled or disabled. In accordance with another aspect of the invention, the status of either the EPT or ECT counter, or both, can be responsive to the occurrence or non-occurrence of a particularly defined event. In accordance with yet another aspect of the invention, the status of either the EPT or ECT counter, or both, can be selective, depending on the occurrence or non-occurrence of a particularly defined event, and the current system load. In accordance with yet another aspect of the invention, the status of either the EPT or ECT counter, or both, can be selective, depending on the occurrence or non-occurrence of a particularly defined event, and anticipated system load. Anticipated system load can predicted using predictive analytics, or estimated.

When the EPT and ECT counters are enabled, they each make decisions about pre-fetching the data and writing back data from the cache to the lower memory levels based on pre-determined decision-making criteria. The pre-fetch decisions made by the EPT are independent of the decisions made by the ECT. Accordingly, while same data may be employed in this decision making process, the outcome of the EPT decision will not influence the ECT counter decision-making in accordance with one aspect of the invention.

A particular FIFO can have EPT and ECT with minimum values, wherein data corresponding to that FIFO has a miminal chance of being modified before the data is utilized. Alternatively, the FIFO can have EPT and ECT counter with maximum values, wherein data corresponding to that FIFO would have a significant probability of changing before the date is utilized. It can be appreciated that usefulness of the counters varies, decreasing as the counter values increase until the situation occurs that the counters have maximum values that would be virtually meaningless. Accordingly, the EPT and ECT counters would be disabled in accordance with the present invention when the counter values reach a maximum threshold.

The maximum counter threshold is an indication of how much space can be reserved for processing. According to one aspect of the invention, the counter threshold is pre-determined. According to another aspect of the invention, the counter threshold varies depending on the nature of a particular processor transactions and is statically based on a schedule of tasks for various processors. According to yet another aspect of the invention, the counter threshold is dynamic, varying with a pre-determined throughput optimization scheme.

Where the EPT and ECT data is near the maximum threshold value corresponding to that FIFO, there is a strong probability that the data is not going to be altered in the near future and hence the cache lines occupied by this FIFO can be removed. Therefore, write-back operation for writing back any modified data corresponding to this FIFO is initiated. Simply stated, the data stored in a particular FIFO is queued for victimization when the EPT and ECT counters reach the maximum threshold value.

If the EPT counter has maximum value and is disabled and ECT counter has a small value, it indicates that probably the producer has produced enough data and is scheduled out. The consumer of the data is scheduled on one of the processors and starts consuming the data. If the data for the FIFO is not already cached, then based on the sampled values of ECT counter, appropriate pre-fetch operations are initiated automatically and data corresponding to this FIFO is brought in the cache. The rate of the pre-fetch of the data depends on the processing step and the highest meaningful value of the ECT counter. Accordingly, cache resources are optimized.

If the EPT counter has a smaller value and ECT has maximum value and is disabled. In this case, only the producer is scheduled and consumer is not yet scheduled to run. Therefore, the consumer will not use the data being produced by the producer in the near future. In this case, cache can be operated as a write-back buffer. Appropriate write-back instructions are used to write-back the data being produced by the producer. The rate of the write-back instructions is based on the threshold EPT counter value.

If both EPT and ECT has smaller values and are enabled, then this is the scenario wherein the FIFO's average filling can be small as the data being produced is consumed by the consumer. However, again appropriate pre-fetch and write-back instructions can be used to limit the data in the FIFO if there is huge difference between the processing steps of producer and consumers again based on the meaningful threshold values of EPT and ECT counters.

While the present invention has been described with reference to several particular example embodiments, those skilled in the art will recognize that many changes may be made thereto without departing from the spirit and scope of the present invention, which is set forth in the following claims.

1. An apparatus for processing streams of data, comprising: a processor; at least one level of cache memory in communication with the processor for receiving instructions from the processor and for communicating lines of data to the processor in response to the instructions; a first counter in communication with the cache memory for estimating production times for particular lines of data; a second counter in communication with the cache memory for estimating consumption times for particular lines of data; wherein the first and second counters enable the apparatus to optimize scheduling of the instructions.

2. An apparatus as set forth in claim 1, wherein each counter has a maximum threshold value so that when the maximum threshold value is reached then the counter enables victimization of the cache memory.

3. An apparatus as set forth in claim 1 further comprising multiple processors having a schedule of tasks, the cache memory is in communication with the multiple processors, each counter has a maximum threshold value so that when the maximum threshold value is reached then the counter enables victimization of the cache memory, the maximum threshold value being pre-determined.

4. An apparatus as set forth in claim 1 further comprising multiple processors having a schedule of tasks, the cache memory is in communication with the multiple processors, each counter has a maximum threshold value so that when the maximum threshold value is reached then the counter enables victimization of the cache memory, the maximum threshold value being variable.

5. An apparatus as set forth in claim 1 further comprising multiple processors having a schedule of tasks, the cache memory is in communication with the multiple processors, each counter has a maximum threshold value so that when the maximum threshold value is reached then the counter enables victimization of the cache memory, the maximum threshold value being statically based on the schedule of tasks for the processors.

6. A system for processing streams of data, comprising: a means for processing data including multiple processors, the processors have a schedule of tasks; at least one level of cache memory in shared communication with the processors for receiving instructions from the processor and for communicating lines of data to the processor in response to the instructions; an estimated production time (EPT) counter in communication with the cache memory for estimating production times for particular lines of data; an estimated consumption time (ECT) counter in communication with the cache memory for estimating consumption times for particular lines of data; and the EPT counter and the ECT counter has a maximum threshold value so that when the maximum threshold value is reached then the counter enables victimization of the particular cache memory lines, the maximum threshold value being statically based on the schedule of tasks for the processors.
